(19) United States
(12) Patent Application Publication
(10) Pub. No.: US 2024/0070684 A1
(43) Pub. Date: Feb. 29, 2024

(54) BLOCKCHAIN SYSTEMS AND METHODS FOR VERIFYING THE CERTIFICATIONS AND THE AUTHENTICITY OF COMMERCIAL PRODUCTS

(71) Applicant: SURGIBOX INC., Cambridge, MA (US)

(72) Inventors: Mike Horia Mihail Teodorescu, Cambridge, MA (US); Atif Mohammad Rakin, Storrs, CT (US); Gelu Comanescu, Washington, DC (US)

(73) Assignee: SURGIBOX INC., Cambridge, MA (US)

(21) Appl. No.: 17/900,029

(22) Filed: Aug. 31, 2022

(51) Int. Cl. G06Q 30/00; H04L 9/00

(52) U.S. Cl. CPC G06Q 30/0185; H04L 9/50

(57) ABSTRACT

Systems and methods for verifying the certifications and the authenticity of commercial products is disclosed. The system receives photos of the commercial product and the labels displayed on the product. The system performs image recognition on the labels and extracts the certification marks on the product. The system accesses a certification-database and verifies if proper certifications exist for the product. The systems include a product registration-system where manufacturers registered their products by uploading photos of the products and their labels. Registered-product-records are formed for each registered product and are rendered immutable via a blockchain. A user investigates if a product in the stream of commerce is an authentic product by uploading photos of the product on the registration-system. The information extracted from the photos is compared with the information in the corresponding registered-product-record. Geolocation information of the investigated products is acquired. An authenticity status is determined for the investigated product.

### BACKGROUND OF THE INVENTION

### I. Field of the Invention

Exemplary embodiments of the present invention relate to systems and methods for verifying the certification of commercial products and for verifying the authenticity of commercial products.

### II. Discussion of the Background

Current regulatory certification, especially by medical device notified bodies and other large international certifying agencies, are not easily or centrally verifiable. As a result, counterfeit products often enter into the stream of commerce and stay undetected for long periods of time. Also, the practice of counterfeiting regulatory certifications and counterfeiting certification marks on devices and products so as to appear as legitimate products is not an uncommon practice. Thus, consumers have difficulty distinguishing a counterfeit certification on a product label from a genuine one.

According to a reputable medical device regulatory authority, there are several systemic failures that enable counterfeiting. For example, most regulatory authorities (e.g., the ones pertaining to CE marking in the European Union) don't require actual test reports for some categories of low-risk devices. Also, many manufacturers do not have the equipment necessary to verify compliance with all required standards. As a result, even when a test report exists, it can be difficult to verify if the actual and correct tests were performed. Further, regulatory process can be notoriously long and expensive and, as a result, some parties are trying to find ways to avoid it.

Various notified bodies have certification lookup systems published online. These systems however require sufficient information on the device and are not necessarily presented in a user-friendly manner. For example, some searches require standard or accreditation type information to return a correct system or product certification, which is not obvious to many consumers. Additionally, such lookup systems return only the associated certification and do not return product information. Such lookup systems verify the existence of the certification for a particular product type or company but do not provide verification that other information on the product, such as associated dates, lot numbers, or product numbers, match with officially released and certified products.

Counterfeit products enter the stream of commerce in many technology fields, such as medical devices, electronic devices, raw materials, automotive parts, aircraft parts, batteries, safety devices, etc. For example, in 2008 a global regulatory certification agency put out a warning about counterfeit automatic fire sprinklers. The counterfeit fire sprinklers were marked with a false label of certification and have not received the required safety and regulatory testing (as mentioned in Reference 8). Moreover, these counterfeit products were labeled with the company name of a reputable certified company which manufactured very similar fire sprinklers. In some cases, these differences came down to slight changes in screw types and bulb size and quality. These counterfeit fire sprinklers were fraudulently labeled to come from a reputable USA based company and found in international markets such as Kuwait.

In a similar 2021 case, counterfeit fire sprinklers that have passed no documented safety or regulatory testing were commercialized on USA and Canadian markets. These products were fraudulently labeled as manufactured by a reputable manufacturer (see Reference 3). The risk to the public of using such counterfeit products is obvious. A malfunctioning fire sprinkler system can lead to injury and loss of property. In 2021 a regulatory agency (Underwriters Laboratories) released twelve public notices pointing out to various counterfeit marked devices, such as smoke alarms, USB charging devices, and communication cables posing a fire hazard. All of these counterfeit devices lacked verifiable safety testing and, as a result, posed safety risks to the users and the public.

Fraudulently marked devices marketed as being made by reputable certified companies can damage company's business reputation. In these cases, looking up the associated device certification is insufficient since the product type, product name, and manufacturer/company name of the counterfeit product matches the general product certification even though the counterfeit product is slightly different from the authentic product.

In another situation, counterfeit products are fraudulently marked and enter the stream of commerce without being properly certified (such products often do not mimic an existing legitimate product). These counterfeit products are easier to detect since a certificate cannot be found when a search is performed for the product. Such as case, was pursued by the US Government in 2013 with respect to an US based company which imported unauthorized counterfeit regulatory marked products over multiple years (in this case lamp bulbs worth millions of dollars of counterfeit product, see Reference 4).

In early 2010s an independent study was conducted on twenty-seven battery-chargers on the UK market. All twenty-seven chargers carried the appropriate regulatory marks—in this case the CE mark; eight of the chargers were labeled as manufactured by well-known companies (e.g., Motorola, Nokia), whereas the remaining nineteen chargers were manufactured either by comparatively smaller companies or were all together unbranded products. In this independent study, all eight of the branded chargers were both CE marked and passed the required electrical and usage tests. However, all the unbranded chargers, though carrying the appropriate regulatory markings, failed to pass required electrical safety and usage tests. Products failing the safety and usage tests are likely to carry some level of risk to users and public. Especially for unbranded devices and products, there is no formal or centralized way to track certification and testing information (see Reference 7). The risk for users and the public of using counterfeit products is especially high when the product is a medical device.

Combating the practice of counterfeit regulatory markings is an important societal concern actively pursued by multiple international regulatory agencies. There are currently many efforts, at the international level, to combat counterfeiting. Many conferences and symposia are held to discuss the impact of counterfeit devices and strategies for combating counterfeiting. These symposia cover topics such as the financial impacts of counterfeiting, ways to detect counterfeit products, secure branding, and strategies for combating counterfeiting.

Several methods and strategies have been employed to detect counterfeit products and to prevent counterfeiting. For example, some European medical device notified bodies participate to trade shows where they comb through the presented medical devices. It appears that regulatory authorities have found this method as somewhat efficient. In addition, several regulatory authorities have trademarked their certification symbols (e.g., the CE mark of the European Union) in order to prevent others to improperly use their certifications.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

### SUMMARY OF THE INVENTION

Exemplary embodiments of the present invention provide a label-verification-system for verifying the certifications and the authenticity of commercial products. The label-verification-system may include a user-input-device enabling an user to investigate products and to input requests into the label-verification-system. The label-verification-system may further include a camera configured to take a photo of a product-label and to generate a label-photo. The label-verification-system may be connected with processing-module configured to perform image recognition on the label-photo and to extract text and images from the label-photo. The processing-module may be configured to generate, from the text and images, a label-record including one or more of product serial numbers, product lot numbers, product information, manufacturer information, one or more certification-logos, certification-marks associated with each of the certification-logos, and one or more warning messages. The processing-module may be configured to determine a certification-mark-compliance-status for each of the certification-logos and the corresponding certification-marks. The processing-module may perform one or more of the following: compare the certification-logo with a set of standard-certification-marks, determine a standard-certification-mark most similar to the certification-logo, evaluate a degree of similarity between the certification-logo and the most similar standard-certification-mark, and calculate a certification-logo-design-status based on the degree of similarity.

The label-verification-system may further include an electronic-display configured to display the certification-mark-compliance-status for each of the certification-logos and the corresponding certification-marks. The label-verification-system may also be configured to determine, for each of the certification-logos, a certification-logo-design-status indicating whether the design of the certification-logo is compliant with the design requirements for the certification-mark corresponding to the certification-logo. The electronic-display may display the certification-logo-design-status.

The label-verification-system is configured to access a certificates-database comprising a plurality of product-certificates. The processing-module may input into the certificates-database the label-record and extract from the certificates-database one or more product-certificates associated with the product-label. The processing-module may determine for each of the certification-marks on the product-label whether a corresponding valid product-certificate exists in the certificates-database. Based on this, the processing-module determines a certification-mark-compliance-status for each of the certification-marks. The label-verification-system is configured to display on the electronic-display each of the certification-marks of the product-label and the corresponding certification-mark-compliance-status. The label-verification-system is further configured to display on the electronic-display the product-certificates for each of the certification-marks for which a product-certificate exists in the certificates-database.

Exemplary embodiments of the present invention also provide a product-registration-system for registering and verifying commercial products. The product-registration-system may include an information-receiving-module configured to receive from a manufacturer-input-device a manufacturer-product-dataset comprising information about a manufacturer-product and its label. The product-registration-system may include a registration-database configured to store the registered-product-record and other product-records. The system may receive from an user-input-device an investigated-product-dataset corresponding to an investigated-product. A comparison-module may extract product information from the investigated-product-dataset and determine if the registration-database comprises a product-record matching the investigated-product. The comparison-module may find in the registration-database a matching-registered-product-record for the investigated-product and compare the information in the investigated-product-dataset with the information in the matching-registered-product-record. Based on the comparison the module may determine a product-compliance-status for the investigated-product.

The registered-product-record may include one or more of the following pieces of information regarding the manufacturer-product and the manufacturer-label: product serial numbers, lot numbers, product information, manufacturer information, one or more certification-logos, certification-marks associated with each of the certification-logos, one or more warning messages, the manufacturer-product-photos, and the manufacturer-label-photos. This information may be obtained by performing image recognition on the manufacturer-label-photo and the manufacturer-product-photos and extracting text and images from the photos. The product-registration-system is connected with a processing-module configured to perform image recognition on the investigated-product-photos and the investigated-label-photos. The processing-module extracts text and images from the investigated-product-photos and generates an investigated-product-dataset. The investigated-product-dataset includes one or more of the following: product serial numbers, product lot numbers, product information, manufacturer information, one or more certification-logos, certification-marks associated with each of the certification-logos, one or more warning messages, the investigated-product-photos, and the investigated-label-photos.

The product-registration-system compares the investigated-product-photos with the manufacturer-product-photos and determine if they match with each other. Based on this, a product-matching-status is determined. The product-matching-status indicates whether the manufacturer-product-photos and investigated-product-photos match with each other. The registered-product-records include one or more record-datasets. Each of the datasets may be rendered immutable by storing on a blockchain copies of the datasets or hashes of the datasets.

The product-registration-system may include a product-authentication-module configured to determine an authenticity-status of investigated-products. The authenticity-status of the investigated-product includes information whether the investigated-product is an authentic-product or a counterfeit-product. The product-authentication-module may include a geolocation-module configured to determine a geographical location of investigated-products by determining the geographical location of the user-input-device. The product-authentication-module may form a location-record including the geographical location of the investigated-product and the corresponding investigation-time, which can be stored in the form of a timestamp. The product-registration-system may include a chain-of-custody-module configured to receive information about a chain-of-custody for the investigated-product.

The product-authentication-module may form a location-dataset corresponding to the registered-product and its associated registered-product-record. The location-dataset may include a plurality of location-records corresponding to instances when user-input-devices, at a plurality of geographical locations and investigation-time, have sent to the product-registration-system investigated-product-datasets leading to the registered-product-record of the registered-product. The product-authentication-module may estimate the authenticity-status for the investigated-product by analyzing one or more of the following: a product-matching-status, a certification-mark-compliance-status, a chain-of-custody, a location-record of the investigated-product, and a location-dataset. The product-authentication-module may estimate for each of the location-records if the geographical location and the investigation-time corresponding to the location-record is consistent with the investigation of an authentic product or with the investigation of a counterfeit product. For each registered-product-record, the product-authentication-module may display a list of all the location-records in the location-dataset and their corresponding authenticity-status.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows schematically a sample label of a commercial product for illustrative purposes.

FIG. 2 shows schematically a compliance-certificate issued by a sample certification authority, the compliance-certificate corresponding to a certification mark displayed on a label of a commercial product.

FIG. 3(a) shows a diagram of an exemplary embodiment of a certificates-database-system including a certificates-database configured to store compliance-certificates.

FIG. 3(b). shows an exemplary embodiment of a hash-module of a blockchain-based-system, the hash-module being configured to employ a hash-function to calculate certificate-hashes for the certificates.

FIG. 4(a) shows the “Conformité Européenne” CE mark used to indicate conformity with certain standards of the European Union.

FIG. 4(b) shows the “China Export” CE mark used to indicate that the product was manufactured in China.

FIG. 5 shows schematically a diagram of a label-verification-system including a logo-design-verification-module.

FIG. 6(a) shows schematically a diagram of a label-verification-system including a certification-compliance-module connected with a certificates-database and a blockchain.

FIG. 6(b) shows an exemplary embodiment of a list including certification-marks of the product-label and their corresponding certification-mark-compliance-status.

FIG. 7 shows schematically a diagram of a label-registration-system including a label-registration-database and a label-records-blockchain.

FIG. 8 shows an exemplary embodiment of a product-registration-system including a product-registration-database and/or a product-records-blockchain.

FIG. 9 shows an exemplary embodiment of a hash-module of a blockchain-registration-system, the hash-module being configured to employ a hash-function to calculate dataset-hashes for the registered-product-records.

FIG. 10 shows an exemplary embodiment the blockchain-registration-system 50 which is further configured to verify periodically and/or at various times the integrity of any one of the registered-product-records.

FIG. 11 shows an exemplary embodiment of a manufacturer-account displayed on a manufacturer-input-device, such as a smart-phone.

FIG. 12 shows schematically a diagram of a process by which a user may use the product-registration-system to investigate the authenticity of an investigated-product.

FIG. 13 shows an exemplary embodiment of an investigated-product-compliance-status displayed on a user-input-device, such as a smart-phone or a computer display.

FIG. 14 shows an exemplary embodiment of a location-dataset corresponding to a registered-product-record.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough and will fully convey the scope of the invention to those skilled in the art. Like reference numerals in the drawings denote like elements.

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

(1). Product Labels and Certification/Attestation Marks.

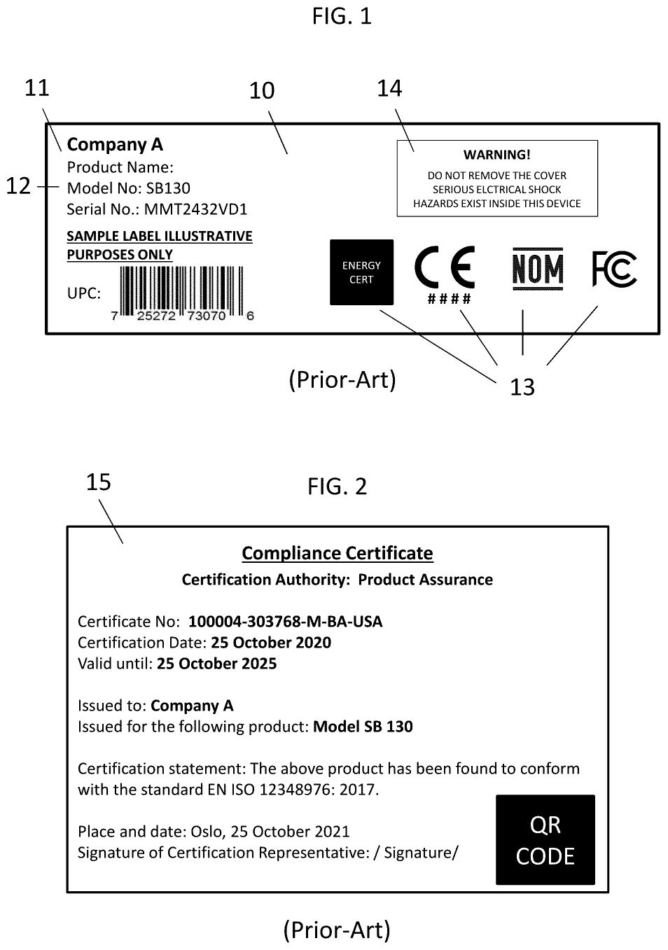

FIG. 1 shows an exemplary embodiment of a label 10 of a commercial product. The label typically includes manufacturer information 11, such as a manufacturer's name, address and logo; product information 12 such as a product serial number, lot number, or Universal Product Code (UPC) number; one or more certification or attestation logos and/or marks 13; one or more warning boxes and signs 14. The label may further include a barcode or a QR code encoding product or manufacturer information. The label may be affixed on the corresponding commercial product or on packaging of the commercial product.

The certification marks 13 may attest that the product is compliant with specific certification standards, such as quality standards, industrial standards, and health & safety standards. For example, the CE mark of the certification/attestation marks 13 may indicate that the product has been assessed and deemed to meet EU safety, health and environmental protection requirements. The FCC mark may indicate that the product meets certain standards of the US Federal Communications Commission. The Energy Star mark may indicate that the product meets certain standards of the US Environmental Protection Agency. Certification/attestation marks have to satisfy specific design requirements imposed by the certification authority (e.g., FCC authority for the FCC mark). For example, the FCC authority provides and makes available to the public the specific FCC standard-mark-design shown at 13 in FIG. 1. In order to certify that a product satisfies FCC standard the label needs to show the mark provided by the FCC. Designs which are different from the standard-mark-designs are not compliant with the requirements imposed by FCC and may not have the legal effect provided by the FCC mark. Accordingly, it is important that the certification marks used on the product have the standard-mark-design required by the certification-authority.

(2). Compliance-Certificates issued by Certification Authorities

Certification authorities often provide compliance-certificates attesting that a product satisfies a certain standard (e.g., health and safety standard, quality standard, suitability for use in certain circumstances). FIG. 2 shows schematically an exemplary embodiment of a compliance-certificate issued by a certification authority, the compliance-certificate corresponding to a certification mark displayed on a label of a commercial product. The compliance-certificate may include one or more of the following: name and address of the certification-authority; a unique certificate number identifying the certificate; a certification date; the identity of the manufacturer to whom the certificate is issued to; the product for which the certificate has been issued; a certification statement identifying the specific standard that the product complies with; a logo and signature of the certification authority; and a QR code (or an internet address) pointing to a digital copy, stored at the internet address, of the compliance-certificate. An example of such certification authority for European standards is the DNV Product Assurance AS of Norway.

(3). Certificates-Database-Systems.

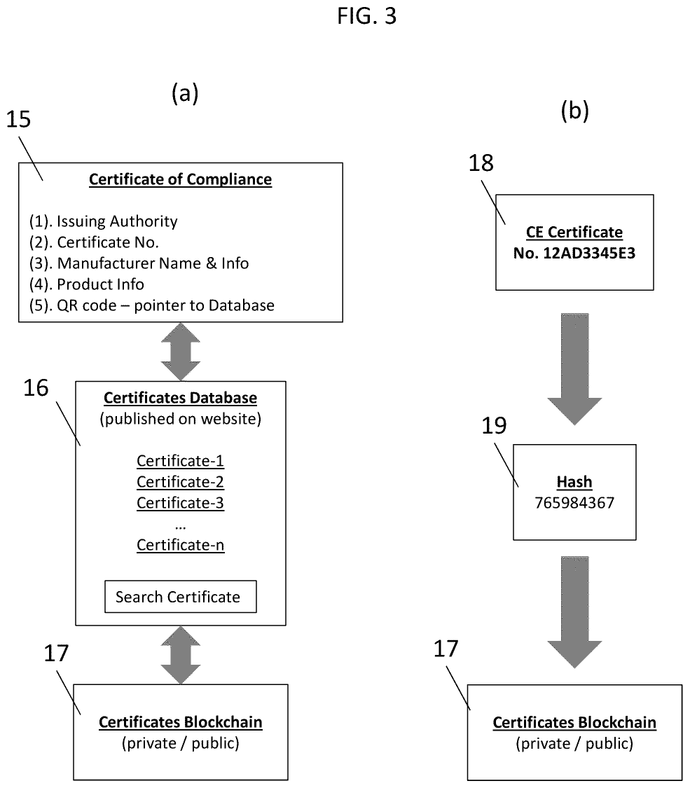

FIG. 3(a) shows a diagram of an exemplary embodiment of a certificates-database-system including a certificates-database 16 configured to store compliance-certificates 15. The certificates-database may be connected with a certificates-blockchain 17. Compliance-certificates issued by a specific certification-authority may be stored on a certificates-database hosted by the specific authority. The certificates-database may enable the public to search and view compliance-certificates for a specific product. For example, the certificates-database may include an online search box enabling users to enter information about the product (e.g., UPC number, manufacturer name and product name, QR code, etc.) and to view and/or retrieve the specific certificates issued by the authority for the product.

(4). The self-certification-database system.

Some certifications do not require obtaining a compliance-certificate from a certification-authority but instead require a self-certification and/or a declaration that the product meets all the legal requirements associated with using the specific marking. For example, the European Commission imposes the following requirement on a manufacturer displaying the CE mark (see 13 in FIG. 1) on a product: by displaying the CE mark the manufacturer declares that the product meets all the legal requirements for CE marking and can be sold throughout the European Economic Area.

An exemplary embodiment of the invention discloses a self-certification-database-system including a plurality of declarations and/or self-certifications submitted by manufacturers. The self-certification-database may be stored on one or more memory-modules of one or more computer servers or in a data center. The self-certification-database system may receive from manufacturers the self-certified-documents and the declarations. The self-certification-database may make the self-certified-documents and declarations available to the public via a website by posting them on webpages and providing links for accessing, viewing and/or downloading the declarations and self-certified-documents. The self-certification-database system may be implemented as a service provided by a commercial entity.

(5). The Centralized-Database System

An exemplary embodiment of the invention discloses a centralized-database system including a centralized-database aggregating the information (e.g., the compliance-certificates) of several certificates-databases run by several certification-authorities. The centralized-database may further include one or more self-certification-databases. The centralized-database system may be implemented via an online website providing access to the compliance-certificates in the several certificates-databases. For example, the centralized-database may be implemented via a website providing access links to a first-certificates-database implemented by a first-certification-authority (e.g., the Federal Communication Commission); access links to a second-certificates-database implemented by a second-certification-authority (e.g., the DNV Product Assurance AS); access links to a third-certificates-database implemented by a third-certification-authority (e.g. the US Environmental Protection Agency); and access links to a self-certificates-database implemented by a commercial entity providing self-certification services. The centralized-database system may include a search module enabling users to enter information about the product (e.g., UPC number, manufacturer name and product name, QR code, etc.) and to view and/or retrieve from the centralized-database the one or more certificates corresponding to the product.

(6). Using Blockchain to Secure Certificates.

The compliance-certificates, the self-certifications, and the declarations may be rendered immutable via a public blockchain or a private blockchain associated with the certificates-databases. The compliance-certificates, the self-certifications and the declarations may be referred hereinafter as “certificates” whereas certificates-databases, the self-certification-databases, and the centralized-database may be referred as “databases” or “certificates-databases”.

In an exemplary embodiment of the invention a blockchain-based-system for rendering the certificates immutable is disclosed as seen in FIGS. 3(a) and 3(b). The blockchain-based-system may include a blockchain which may be either public or private. In an exemplary embodiment, the blockchain-based-system may store on the blockchain digital versions of the certificates, wherein each of the certificates has a specific address on the blockchain. The blockchain-based-system may further store the blockchain-addresses in the database. The blockchain-based-system may further store links to the blockchain-addresses and/or certificates on a website associated with the database so as to allow the public to view and access specific certificates.

FIG. 3(b). shows an exemplary embodiment of a hash-module of a blockchain-based-system, the hash-module being configured to employ a hash-function to calculate certificate-hashes for the certificates. The blockchain-based-system stores the certificate-hashes on the blockchain, wherein each of the hashes has a specific address on the blockchain. The blockchain-based-system may further store the blockchain addresses of the certificate-hashes in the database and as associated with their corresponding certificates. For example, consider certificate-1, hash-1 of the certificate-1 stored on the blockchain at time-1, and blockchain-address-1, where hash-1 is stored on the blockchain. Certificate-1 and the blockchain-address-1 will be stored on the database as associated with each other. Hash-1 will be stored on the blockchain at an address pointed out by the block-chain-address-1.

The blockchain-based system may be configured to verify the authenticity of any one of the certificates by calculating a hash of the certificate and comparing the calculated hash with the corresponding certificate-hash stored on the blockchain. For example, once the certificate-1 is stored in the database and its corresponding hash-1 is stored on the blockchain, the blockchain-based-system may verify the authenticity of certificate-1 (at a verification-time which is after time-1) by calculating the “hash” of certificate-1 (as stored in the database at the verification-time) and comparing the calculated hash with the hash-1 stored on the blockchain. If the calculated hash is different from hash-1, then certificate-1 has been corrupted or altered. If the calculated hash is identical with hash-1, then certificate-1 has not been altered. This way the blockchain-based-system is able to periodically verify the authenticity of the certificates and keep the certificates immutable.

(7). The Label-Verification-System and the Logo-Design-Verification-Module.

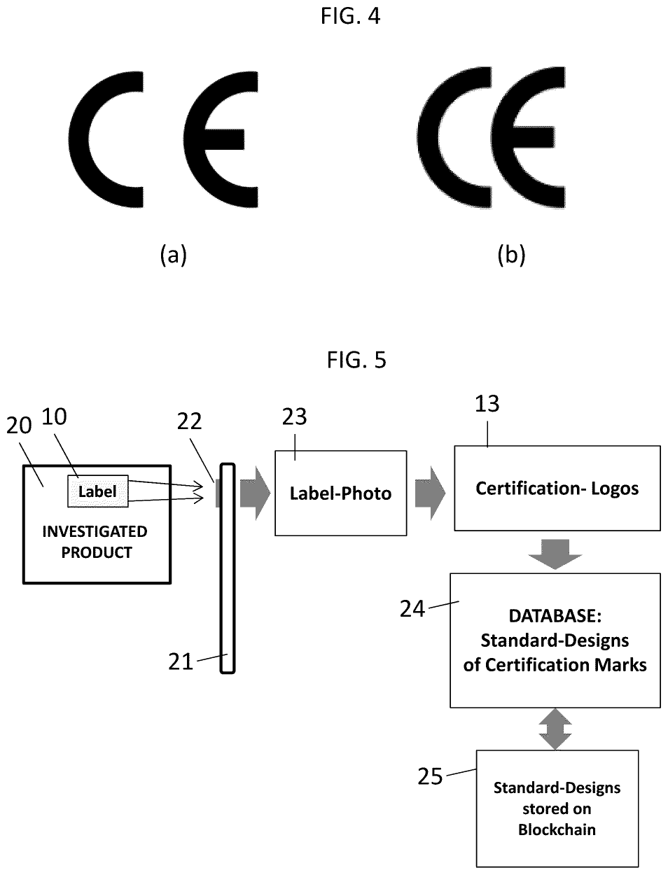

A label-verification-system is disclosed and described hereinafter. The label-verification-system may include a logo-design-verification-module. The logo-design-verification-module is configured to provide a solution to the needs and problems described hereinafter. In some cases two different certification marks may look very much like each other and, because of this, may be used in a deceitful way by manufacturers so as to confuse the public and the authorities regarding the specific certification of a product. For example, FIG. 4(a) shows the “Conformité Européenne” CE mark used to indicate conformity with certain standards of the European Union; whereas FIG. 4(b) shows the “China Export” CE mark used to indicate that the product was manufactured in China. As can be easily seen the two marks in FIGS. 4(a) and 4(b) are very similar and as a result they are often confused with each other (i.e., they differ only by the distance between the “C” and “E” letters, while the design of the letters is identical).

Some manufacturers may intentionally display, on their products, logos made to deceitfully look like a specific certification-mark so as to make the buyers and the authorities believe that the product satisfies standards associated with the certification-mark while in fact the actual logo design is somewhat different from the certification-mark and the product does not satisfy the specific standard. Thus, there is a need for a system and method enabling the public to easily verify if a certain logo on a product label has the specific design of a certain certification-mark.

FIG. 5 shows schematically a diagram of a label-verification-system including a logo-design-verification-module. The logo-design-verification-module is configured to investigate and verify whether labels of commercial products satisfy certain design requirements, such as the requirements set by certification authorities. The label-verification-system may include a user-input-device 21 such as a label scanner or a smart phone. The user-input-device may include a user-device-camera 21, an user-device-processor, an user-device-electronic-display, a transmitter for sending/receiving information over the internet to various online resources. The user-input-device may be connected to a processing-module. The processing-module may be completely included into the user-input-device, may be partially included in the user-input-device, or may have no common components with the user-input-device.

The camera 22 is used to take photos of product labels 10 of a commercial product 20 and to generate digital label-photos 23 of the product label 10. The processing-module may be configured to perform image recognition on the label-photo and to extract text and images from the label-photo. For example, and with reference to FIG. 1, the processing-module may extract the text on the label, such as the manufacturer name, the product serial numbers, and the warning text. Also, with reference to FIG. 1, the processing-module may also extract the certification-logos 13 and may perform image recognition on these certification-logos. The processing-module may include one or more processors disposed on the manufacturer-input-device and/or on other remote devices (e.g., in the cloud, on a processor in a data center). The image recognition may be performed by one or more processors disposed on the user-input-device and/or on other remote devices (e.g., in the cloud, on a processor in a data center).

For example, the processing-module may compare a certification-logo 13 with a set of standard-certification-marks pre-stored by the system (e.g., set of standard certification-marks such as the Energy Star mark, the FCC mark, the “Conformité Européenne” CE mark) to determine the standard-certification-mark most closely resembling the certification-logo 13. The standard-certification-marks may be pre-stored in a database 24 accessible by the logo-design-verification-module. Then the processing-module may evaluate a similarity-degree between the certification-logo 13 and the most closely resembling standard-certification-marks and may determine a similarity-degree between the certification-logo 13 and the most similar standard-certification-marks. The similarity-degree may be expressed by a number from 0 to 100, where 100 represents perfect match between the compared images. If the similarity-degree between the certification-logo and a specific standard-certification-mark is higher than a certain predetermined number, then the certification-logo is found to satisfy the design requirements for representing the standard-certification-mark. If the similarity-degree is lower than a certain predetermined number, then the certification-logo is found to not satisfy the design requirements for representing the standard-certification-mark. This way, the label-verification-system may determine if the certification-logos 13 satisfy the design requirements of any of the standard-certification-marks and the corresponding standard-certification-mark each of the certification-logos 13 represents.

The logo-design-verification-module may be configured to evaluate for each of the certification-logos a certification-mark-compliance-status including the results of the above investigation. The user-device-electronic-display may be configured to display the results of the above investigation process. Specifically, the user-device-electronic-display may display, for each of the certification-logos 13, the corresponding certification-mark which the logo represents and if the logo satisfies the design requirements.

In another embodiment, the logo-design-verification-module may capture additional visual elements of the product and compare them to features of the genuine product of a certain serial number of production lot of the genuine product. For instance, a user may take a photo of a product in a particular orientation (e.g., top view, side view, etc.) as prompted by an application on a smartphone with two or more cameras. The two or more cameras which are typical in many smartphone models in current use may provide input to the processing-module regarding whether the image taken by the smartphone of the product is within a reference frame of a prior stored genuine product photo (which may be pulled from a database or provided from the manufacturer directly, for instance). The stereoscopic vision is only necessary to improve precision of the feature decomposition and may be removed as a requirement for the system in some embodiments, where only one camera may be present and a lower bound of similarity may be set. The image taken by the user of the product being verified is compared with a reference photo of a genuine version of the product; in a non-limiting embodiment this reference photo may be from the same lot and/or the same product unique ID number as provided from the label-verification-system's read of the product label. Should the lot number and/or unique product ID number match a genuine product lot and/or ID, additional verification may be performed by decomposing the photo of the product in the particular orientation requested by the smartphone application into image features that may be compared to reference features.

In a non-limiting embodiment, a smartphone may take photos of the product with and without flash (‘product-photos’), and similarity scores may be calculated for the input image in the flash/no flash conditions with a corresponding pair of product reference images in flash/no flash conditions (‘reference-product-photos’). Reflections off of non-genuine products may differ when compared to genuine product reference photos taken under the same conditions. These product reference images may be uploaded by the product manufacturer, taken with a camera under flash/no flash conditions, and at a reference distance and/or framing of the product. Features may comprise geometric shapes, light reflections on specific components of the image, color of certain features, texture components, edges, etc. Image feature tensors may be extracted in some embodiments. Filters may be used in some embodiments. Regardless of the embodiments or features used, the image features extracted from the product-photos are compared to the reference-product-photos to improve the accuracy of the label-certification-system by adding an additional layer of verification on top of the features of the label itself, in certain embodiments.

The designs of the standard-certification-marks may be rendered immutable via a public blockchain or a private blockchain. In an exemplary embodiment, the images and/or designs of the standard-certification-marks may be stored on a blockchain 25, wherein each of the standard-certification-marks has a specific address on the blockchain. The user-input-device may be configured to access the blockchain addresses of the standard-certification-mark. In another exemplary embodiment, the blockchain may store hashes of the standard-certification-marks, wherein each of the hashes corresponding to a standard-certification-mark has a specific address on the blockchain. The user-input-device may be configured to access the blockchain addresses of the hashes.

(8). The Certification-Compliance-Module.

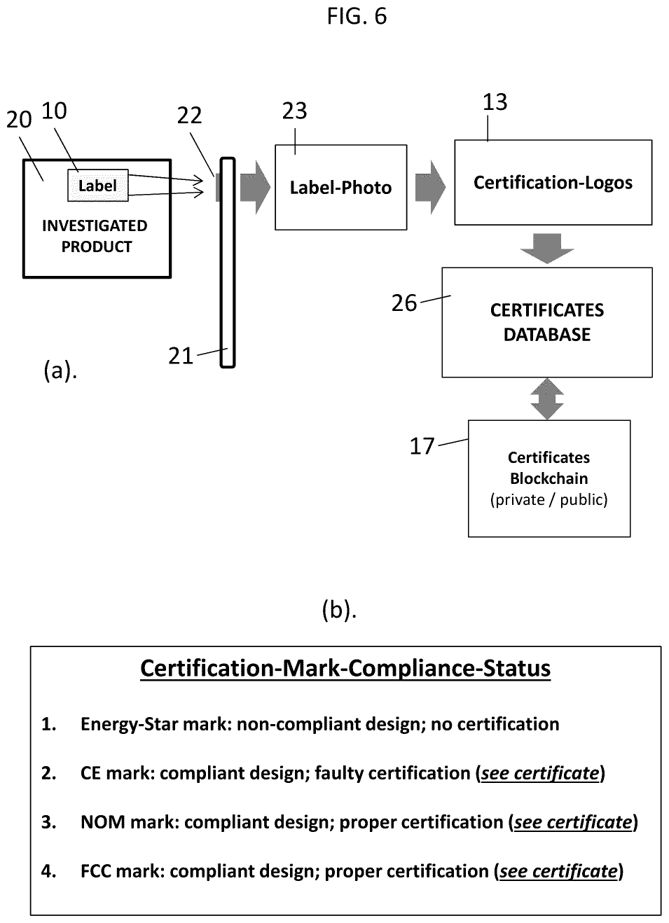

FIG. 6(a) shows schematically a diagram of a label-verification-system including a certification-compliance-module connected with a certificates-database and a blockchain. The certification-compliance-module is configured to provide a solution to the needs/problems described hereinafter. Certain manufacturers use certification-marks on products for which they did not obtain the necessary certifications from the certification authorities or for which they did not have a proper declaration. For example, a manufacturer may display on a product label the “Conformité Européenne” CE mark while the product was not properly verified and/or certified by a proper certification authority (as is required for many products). This way the manufacturer may be able to deceive buyers and authorities that the product satisfies the standards associated with the certification mark when in fact the product does not satisfy these standards. Thus, there is a need for a system and method enabling the public to easily verify if the certification-marks displayed on a product label are properly used (i.e., the manufacturer has obtained the proper certifications and/or has made the proper attestations/declarations required by the certification-marks).

The certification-compliance-module may be connected with a certificates-database 26, such as the certificates-databases described above (e.g., certificates-databases, self-certification-databases, centralized-database) and may be configured to access the certificates associated with a specific product (i.e., product-certificates). The certificates may include compliance-certificates, declarations and self-certifications as described at sections 3-5 above. The certificate in the certificates-database may be rendered immutable via the certificates-blockchain 17 (see FIGS. 3 and 6).

A user may use the label-verification-system to take a label-photo of a commercial product the user wants to investigate. The label-verification-system may extract from the label-photo information, such as product serial numbers, product lot numbers, product information, manufacturer information, certification-logos, certification-marks associated with the certification-logos, warning boxes and text, etc. The label-verification-system may further form a label-record including some of the above product and manufacturer information. The label-verification-system may use the label-record to retrieve from the certificates-database one or more product-certificates associated with the product-label and to determine for each of the certification-marks on the product-label whether a corresponding valid product-certificate exists in the certificates-database.

The information generated by the label-verification-system may be used to determine a certification-mark-compliance-status for each of the certification-marks on the product label. The certification-mark-compliance-status indicates whether a certification-logo and its corresponding certification-mark complies with the required standards and whether a valid product-certificate for the certification-mark exists in the database.

The label-verification-system may be configured to display on the user-device-electronic-display a list including each of the certification-marks of the product-label and the corresponding certification-mark-compliance-status. FIG. 6(b) shows an exemplary embodiment of a list including each of the certification-marks of the product-label in FIG. 1 and the corresponding certification-mark-compliance-status. The label-verification-system may be further configured to display on the user-device-electronic-display the product-certificates for each of the certification-marks for which a product-certificate exists in the certificates-database.

In addition, the label-verification-system may also determine whether the label complies with other requirements and good practices. For example, the label-verification-system may determine if the manufacturer information and/or product-serial numbers, as displayed, satisfy certain requirements and good practices; the label-verification-system may determine if the warning boxes and the text and logos within the boxes comply with requirements and product safety standards imposed by various authorities; and/or the label-verification-system may determine if needed information is displayed on the label and if the arrangements of elements on the label and the general configuration of the label is proper and/or satisfies various standards and good practices.

(9). The Product-Registration-System.

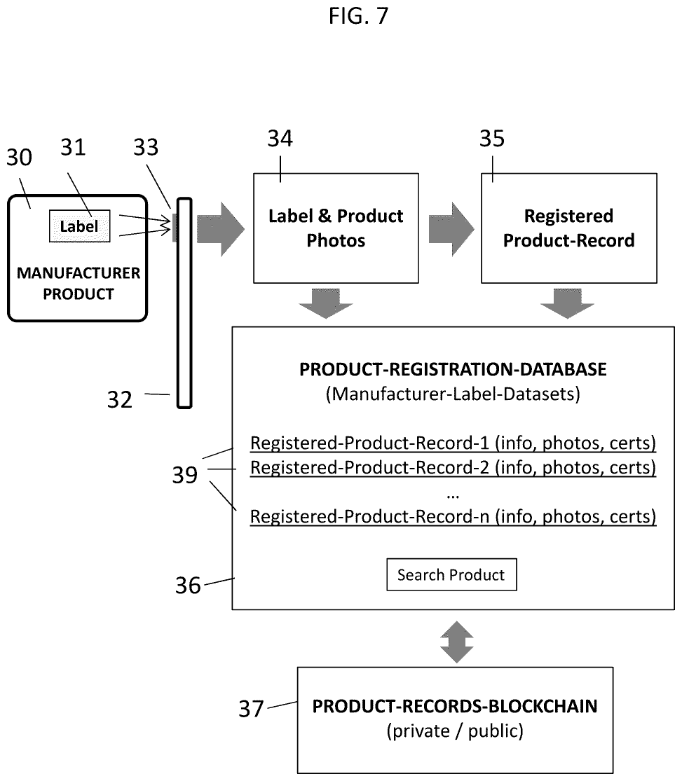

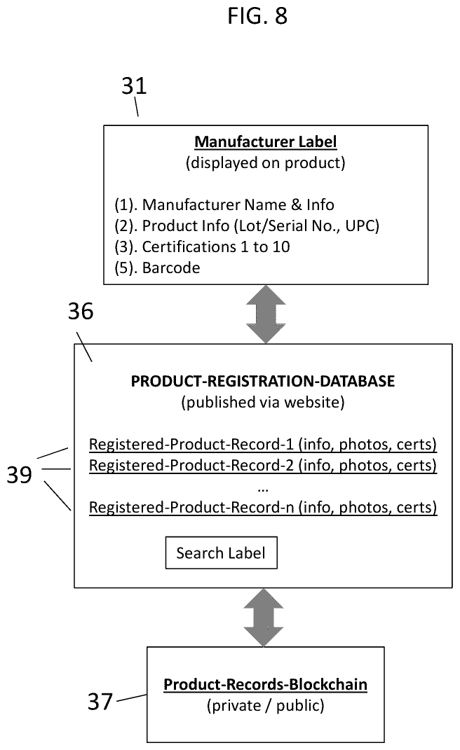

A product-registration-system for registering and verifying commercial products is disclosed. FIG. 7 shows schematically a diagram of a product-registration-system which may include a product-registration-database 36 and/or a product-records-blockchain 37. FIG. 8 shows a diagram of a product-registration-system which may include a product-registration-database 36 and/or a product-records-blockchain 37. The product-registration-system may also include a label-verification-system and the certification-compliance-module as described above. The product-registration-system is configured to provide a solution to the problem of counterfeit products and goods. As well known, many products entering commerce are counterfeit products, which means that the product has a label representing the product as made by one manufacturer (e.g., a well-reputed manufacturer) while in actuality the product is made by a counterfeiter (i.e., a party which makes counterfeit products). Labels on counterfeit products often include misrepresentations, such as: that the product is made by a well-known reputed manufacturer when in fact the product is made by a counterfeiter; that the product satisfies certain safety, health and/or quality standards and is covered by certain certifications when in fact the counterfeiter did not obtain the represented certifications and the product does not satisfy the advertised safety, health and/or quality standards; that the product is made in one country when in fact the product is made in a different country, etc.

Thus, there is a need for a system and method enabling the public to easily verify if a certain commercial product is the authentic product advertised on the product-label, if the representations made on the product-label are true, and if the product-label is an authentic label affixed by the manufacturer. Hereinafter a manufacturer making, selling and advertising authentic genuine products as represented on the label will be referred as “manufacturer” whereas a party making and selling counterfeit products will be referred as “counterfeiter”.

The product-registration-system may include one or more of the following: an information-receiving-module, a registration-module, an information-storage-module, an investigation-request-module, a comparison-module, and an information-transmission-module.

The information-receiving-module may be configured to receive from a manufacturer-input-device a manufacturer-product-dataset. The manufacturer-product-dataset is a dataset which includes information about a manufacturer-product and its label (referred herein after as manufacturer-label). The manufacturer-input-device may include a manufacturer-device-camera configured to take photos of the manufacturer-label and to form a manufacturer-label-photo. The manufacturer-device-camera may be configured to take photos of the manufacturer-product and to form several manufacturer-product-photos. The manufacturer-label-photo may be processed via image recognition software so as to extract text and images from the manufacturer-label-photo. The product-registration-system may form the manufacturer-product-dataset by using the manufacturer-product-photos, the manufacturer-label-photo, and other input received from the user.

The processing-module may include one or more processors disposed on the manufacturer-input-device and/or on other remote devices (e.g., in the cloud, on a processor in a data center). The image recognition may be performed by one or more processors disposed on the manufacturer-input-device and/or on other remote devices (e.g., in the cloud, on a processor in a data center). The manufacturer-product-dataset may include one or more of the following pieces of information regarding the manufacturer-product and the manufacturer-label: product serial numbers; lot numbers; barcodes including UPC numbers (Universal Product Code); information about the product; manufacturer name, logo and information; one or more certification-logos; certification-marks associated with each of the certification-logos; and one or more warning boxes; caution messages. The manufacturer-product-dataset may further include one or more of the following: the label-photo; a set of product-photos; and an instructions-set describing how a buyer can verify if a product is an authentic manufacturer-product.

A manufacturer may use the product-registration-system as follows: the manufacturer uses the manufacturer-input-device (e.g., smart phone or scanner) to take a photo of the manufacturer-label, to take photos of the manufacturer-product, and/or to upload digital files related to the product (e.g., the instruction-set). A dataset-generation-module on the manufacturer-input-device may be used to generate the manufacturer-product-dataset and to send it to the product-registration-system. The registration-module of the product-registration-system may create a registered-product-record corresponding to the received manufacturer-product-dataset. The registered-product-record may include all or part of the information stored by the manufacturer-product-dataset. The information-storage-module may include a registration-database configured to store the registered-product-record.

The registration-database may include a plurality of registered-product-records 39 (see FIGS. 7 and 8) corresponding to commercial products registered by various manufacturers. Each of the registered-product-records provides information about the registered-label and the corresponding registered-product. The information in each of the registered-product-records may include all or part of the information stored by the corresponding manufacturer-product-dataset, as described in the previous paragraphs (e.g., various info regarding the corresponding manufacturer-product and the manufacturer-label).

(10). The Product-Records-Blockchain

Information datasets in the registered-product-records may be rendered immutable via a blockchain associated with the product-registration-database. It is understood that all or only part of the information in the registered-product-records may be rendered immutable by the blockchain (hereinafter may be referred as product-records-blockchain). In an exemplary embodiment of the invention a blockchain-registration-system for rendering immutable datasets in the registered-product-records is disclosed. The product-records-blockchain may be either a public blockchain or a private blockchain. In an exemplary embodiment, the product-records-blockchain may store datasets included in the registered-product-records. The datasets may store specific information in the record, such as product information, photos, barcodes, etc. Each of the datasets is stored at a specific address on the blockchain. The blockchain addresses of the datasets are stored in the product-registration-database. The product-registration-database may further store a website including links to the blockchain addresses for each of the datasets and their corresponding registered-product-record.

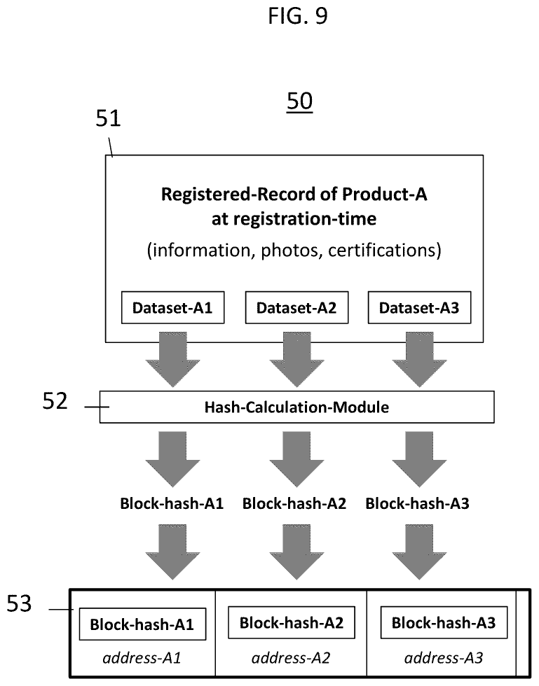

FIG. 9 shows an exemplary embodiment of a blockchain-registration-system 50 including a hash-calculation-module 52, wherein the hash-calculation-module is configured to employ a hash-function to calculate dataset-hashes for the registered-product-records and to store these hashes on the product-records-blockchain 53. For example, consider a specific registered-record for product-A 51 including dataset-A1, dataset-A2 and dataset-A3. The hash-calculation-module 52 may calculate block-hash-A1 for dataset-A1, block-hash-A2 for dataset-A2, and blockc-hash-A3 for dataset-A3 and store these hashes on the blockchain 53. Each of the blockchain-hashes has a specific address on the blockchain (i.e., address-A1, address-A2, address-A3, as seen in FIG. 9). The blockchain address of each of the hashes are associated with their registered-product-records and stored on the registration-database. For example, with reference to FIG. 9, address-A1, addres-A2, and address-A3 are stored in the registration-database as associated with the registered-record for product-A.

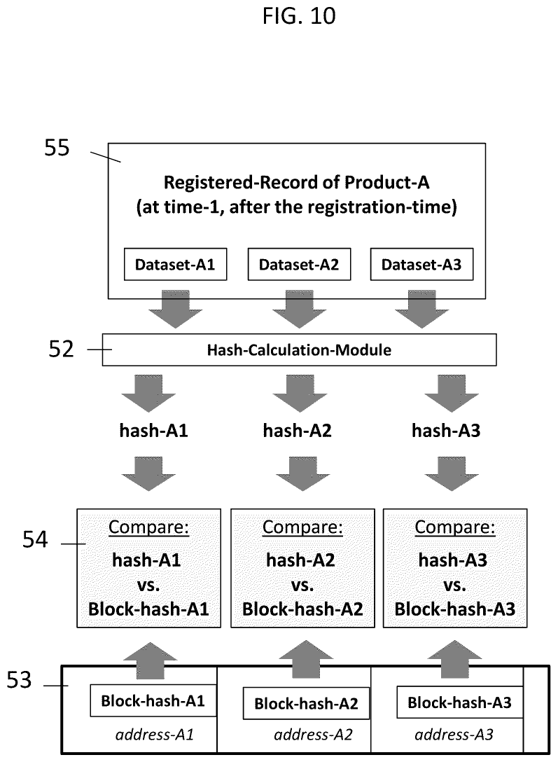

FIG. 10 shows an exemplary embodiment the blockchain-registration-system 50 which is further configured to verify periodically and/or at various times (e.g., time-1 after the registration-time) the integrity of any one of the registered-product-records by calculating the hashes of the registered-product-records (as stored in the registration-database at time-1) and comparing the calculated hashes with corresponding product-record-hashes stored on the blockchain at the registration-time. For example, once the registered-record of product-A is stored in the registration-database and its corresponding hashes (e.g., block-hash-A1 to A3) are stored on the blockchain, the blockchain-registration-system may verify the integrity of registered-record of product-A at a time-1 (55 in FIG. 10) by calculating the “hashes” of the registered-record (as stored in the database at time-1) and comparing the calculated hashes (e.g. hash-A1, hash-A2, hash-A3 at time-1) with the hashed stored on the blockchain 53 (e.g. block-hash-A1, block-hash-A2, block-hash-A3). The blockchain-registration-system 50 may include a hash-comparison-module 54 configured to compare the hashes calculated at various times with the blockchain stored hashes. If the calculated hashes are different from the corresponding block-hashes (e.g., hash-A1 is different form block-hash-A1), then the registered-record of product-A has been corrupted or altered. If the calculated hashes are identical with the block-hashes, then the registered-record of product-A has not been altered. This way the blockchain-registration-system is able to verify (periodically or when needed) the integrity of the registered-product-records and to keep the registered-product-records immutable.

(11). The Manufacturer-Accounts

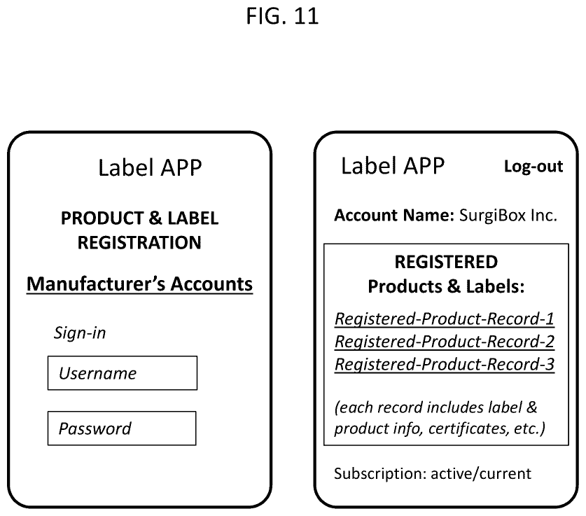

The product-registration-system may further include an accounts-module enabling manufacturers to create manufacturer-accounts. A manufacturer-account may be configured to store one or more registered-product-records, each of them corresponding to a registered-product of the manufacturer. The product-registration-system may be configured to display, at a manufacturer-input-device, the manufacturer-account. FIG. 11 shows an exemplary embodiment of a manufacturer-account displayed on a manufacturer-input-device, such as a smart-phone. The manufacturer may access the manufacturer-account via a username-password interface as seen in FIG. 11 The account may be configured to display manufacturer's registered-product-records for the products (e.g., Product-Record-1, Product-Record-2, Product-Record-3 as seen in FIG. 11) and to enable the manufacturer to access and view the information held by the registered-product-records for each of the products.

(12). How Users Investigate the Authenticity of Commercial Products

A user (e.g., prospective buyer) may use the product-registration-system to investigate and verify the authenticity of a commercial product (hereinafter referred as investigated-product) and/or of the corresponding product label (hereinafter referred as investigated-label) as described in the following. The user may use a user-input-device to take a photo of the investigated-label and/or to take photos of the investigated-product.

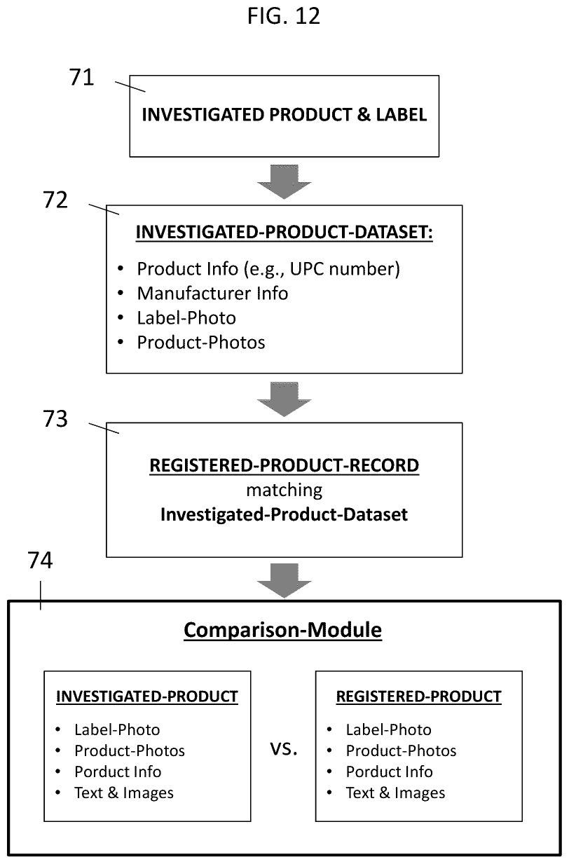

FIG. 12 shows schematically a diagram of a process by which a user may use the product-registration-system to investigate the authenticity of an investigated-product 71. A dataset-generation-module on the user-input-device may be used to generate the investigated-product-dataset 72 and to send it to the product-registration-system. The investigated-label-photo may be processed via image recognition software so as to extract text and images from the investigated-label-photo and to generate the investigated-label-dataset. The image recognition may be performed by one or more processors disposed on the user-input-device and/or on other remote devices (e.g., in the cloud, on a processor in a data center).

The investigated-product-dataset may include one or more of the following extracted pieces of information: product serial numbers; lot numbers; barcodes; information about the product; an alleged manufacturer's name and/or logos; one or more certification-logos; and one or more warning boxes. The investigated-product-dataset may further include one or more of the following: the investigated-label-photo and a set of investigated-product-photos (i.e., photos of the investigated product), features of the image of the product, etc. These features may be verified to correspond to genuine product image features via an automated process.

The investigation-request-module of the product-registration-system may receive, from the user-input-device, the investigated-product-dataset 72. The investigation-request-module may extract from the investigated-product-dataset information identifying the investigated-product 71 and the alleged manufacturer. The investigation-request-module may determine if a specific registered-product-record corresponding to the investigated-product exists. If a registered-product-records does not exist, then the user may conclude that either the manufacturer has not registered the investigated-product (which the user may be able to check with the manufacturer) or that the investigated-product is counterfeit.

Alternatively, the investigation-request-module may find the specific registered-product-record 73 corresponding to the investigated-product. Then, a comparison-module 74 of the product-registration-system may compare the information in the investigated-product-dataset 72 with the information in the corresponding registered-product-record 73. If the investigated-product is indeed authentic and its label has been registered in advance, then the system will find that there is a match between the information in the investigated-product-dataset and the information in the registered-product-record. After determining the registered-product-record 73 and prior to performing the comparison, the product-registration-system may evaluate the integrity of the registered-product-record by using the blockchain 53 and the procedures described with reference to FIG. 10.

The comparing of the information in the investigated-product-dataset 72 with the information in the corresponding registered-product-record 73 may include one or more of: comparing the manufacturer-label-photo with the investigated-label-photo; comparing product and/or manufacturer information in the registered-product-record with product information in the investigated-product-dataset; comparing certification-logos in the registered-product-record with certification-logos in the investigated-product-dataset. The comparison-module is further configured to compare the investigated-product-photos with the manufacturer-product-photos and to determine if they match with each other. The comparison-module is further configured to determine a product-matching-status indicating whether the manufacturer-product-photos and investigated-product-photos match with each other.

The results of the comparisons between the investigated-product-dataset 72 and the registered-product-record 73 may be displayed at the user-input-device so that the user can see if the investigated-product is an authentic product or a counterfeit product. An investigated-product-compliance-status and/or a label-compliance-status may be formed based on the results of the comparisons between the investigated-product-dataset and the registered-product-record. The investigated-product-compliance-status may indicate that the investigated-product and the registered-product match with each other. Conversely, the investigated-product-compliance-status may indicate that the investigated-product and the registered-product do not match with each other and thus the investigated-product is most likely counterfeit. The label-compliance-status may indicate that the investigated-label and the registered-label match with each other. Conversely, the label-compliance-status may indicate that the investigated-label and the registered-label do not match with each other and thus the investigated-label and the investigated-product is most likely counterfeit.

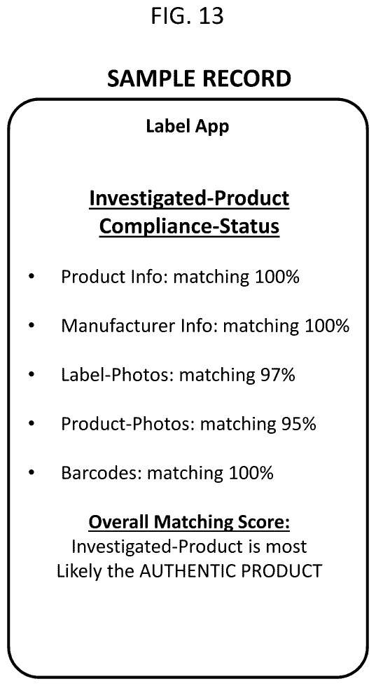

The investigated-product-compliance-status and/or a label-compliance-status may be displayed at the user-input-device so that the user can see if the investigated-product is an authentic product or a counterfeit product. FIG. 13 shows an exemplary embodiment of an investigated-product-compliance-status displayed on a user-input-device, such as a smart-phone or a computer display.

(13). The Product-Authentication-Module.

The product-registration-system may further include a product-authentication-module. The product-authentication-module may be configured to receive information about the chain-of-custody and/or geographical location of a commercial product, to store the information into a product-location file, and to associate the product-location file with the registered-product-record of the product.

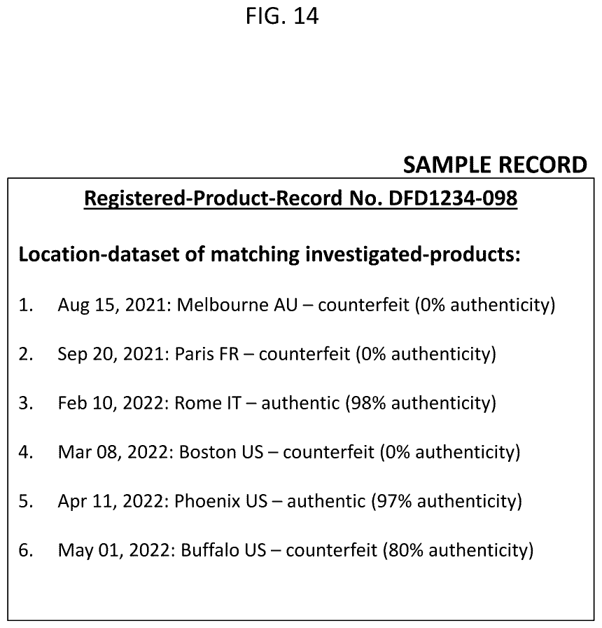

The product-authentication-module works as described in the following. Consider a situation when a user located at a certain location uses a user-input-device to investigate a product via the product-registration-system. The user will take photos of the product and the label. Then an investigated-product-dataset is formed and sent to the product-registration-system. The product-registration-system determines the registered-product-record pointed out by the investigated-product-dataset. The product-registration-system determines the investigated-product-compliance-status as explained in the above paragraphs and sections. The product-authentication-module is configured to receive information about the geographical location of the user-input-device from which the investigated-product-dataset was received and the corresponding investigation-time (i.e., the time at which the investigated-product-dataset was formed). An investigated-product-location-record including the geographical location and the corresponding investigation-time is formed (see e.g., records in FIG. 14).

For each registered-product-record, the product-authentication-module may form a location-dataset corresponding to the registered-product-record and its associated registered-product. FIG. 14 shows an exemplary embodiment of a location-dataset corresponding to a registered-product-record. The location-dataset may include all the location-records (locations and times) corresponding to all instances when user-input-devices have sent to the product-registration-system investigated-product-datasets leading to the registered-product-record associated with the registered-product. An investigated-product-location-record (e.g., item “1” in the list at FIG. 14) may also include an investigated-product-authenticity-status associated with the investigated-product (e.g. “98% authenticity” in record “3” shown on FIG. 14).

The product-authentication-module may calculate the investigated-product-authenticity-status of an investigated-product as function of one or more of the following: the geographical location of the user-input-device measuring the investigated-product and the corresponding investigation-time; the other investigated-product-location-records in the location-dataset; the investigated-product-compliance-status and/or the label-compliance-status of the investigated-product; the expected chain-of-custody of the registered-product. For example, if an investigated-product is located in a place where it is not expected or supposed to be located, then the investigated-product-authenticity-status may indicate that the investigated-product is likely to be counterfeit. This system may aid the manufacturer in training product distributors or sellers into identifying counterfeit versus genuine products.

The skilled artisan would understand that there are multiple ways to define and determine the investigated-product-authenticity-status parameters depending on the circumstances of the specific product. The investigated-product-authenticity-status may be defined/expressed as the probability for the investigated-product to be authentic. For example, the system may determine that the probability that a certain investigated-product is authentic is 80% (which means that there is a 20% probability that the product is counterfeit) and the corresponding investigated-product-authenticity-status may be expressed as “authenticity probability of 80%” (see e.g., record “6” at FIG. 14).

The investigated-product-authenticity-status (e.g., “authenticity probability of 80%”) may be displayed at the user-input-device so that the user can see it. The investigated-product-authenticity-status may also be entered into the investigated-product-location-records of the location-dataset.

The above embodiments presented in this disclosure merely serve as exemplary embodiments and it will be apparent to those skilled in the art that various modifications and variations can be made in the present invention without departing from the spirit or scope of the invention. The terminology used herein is for the purpose of describing particular embodiments only and is not intended to be limiting of the present disclosure. The inventions herein may be embodied in many different forms and should not be construed as limited to the exemplary embodiments set forth herein. Rather, these exemplary embodiments are provided so that this disclosure is thorough and will fully convey the scope of the invention to skilled artisans.

### LIST OF REFERENCES

[1]. https://www.dnv.com/assurance/certificates-in-the-blockchain.html.
[2]. https://www.tuvsud.com/en/services/product-certification.
[3]. https://www.ul.com/news/ul-warns-counterfeit-ul-mark-fire-sprinkler “UL warns of counterfeit UL mark on fire sprinklers” (UL Solutions, 22 Sep. 2021).
[4]. https://www.ice.gov/news/releases/missouri-company-pleads-guilty-importing-18-million-products-counterfeit-safety. US Immigration and Customs Inforcement.
[5]. “A claver way to combat counterfeiting: TUV SUD regsiters “CE 0123” as EU Trademark.” (February 2017), https://www.tuvsud.com/en-us/e-ssentials-newsletter/healthcare-and-medical-devices-essentials/e-ssentials-1-2017/a-clever-move-to-combat-counterfeiting-tuv-sud-registers-ce-0123-as-eu-trademark.
[6]. “Why Manufacturers Lie about CE Marking.” TÜV Rheinland Stories from Asia, Africa and Middle East, https://insights.tuv.com/blog/why-manufacturers-lie-about-ce-marking.
[7]. “What's in Your Socket” UK Government Web Archive, 13 Jul. 2014, https://webarchive.nationalarchives.gov.uk/ukgwa/20140713175508/http %3A/www.buckscc.gov.uk/media/137366/60600_Booklet_proof.pdf.
[8]. “UI Warns of Counterfeit Automatic Fire Sprinklers.” UL Solutions, 18 Jun. 2008, https://www.ul.com/news/ul-warns-counterfeit-automatic-fire-sprinklers.

What is claimed is:

1. A label-verification-system for commercial products, the label-verification-system comprising:
a user-input-device enabling a user to investigate products and input requests into the label-verification-system;
a camera configured to take a photo of a product-label and to generate a label-photo;
wherein the label-verification-system is connected with processing-module configured to perform image recognition on the label-photo and to extract text and images from the label-photo;
wherein the processing-module is further configured to generate, from the text and images, a label-record comprising one or more of the following: product serial numbers, product lot numbers, product information, manufacturer information, one or more certification-logos, certification-marks associated with each of the certification-logos, and one or more warning messages;
wherein the processing-module is configured to determine a certification-mark-compliance-status for each of the certification-logos and the corresponding certification-marks;
an electronic-display configured to display the certification-mark-compliance-status for each of the certification-logos and the corresponding certification-marks.

2. The label-verification-system of claim 1, wherein for each of the certification-logos the processing-module is configured to determine a certification-logo-design-status indicating whether the design of the certification-logo is compliant with the design requirements for the certification-mark corresponding to the certification-logo.

3. The label-verification-system of claim 2, wherein for each of the certification-logos the electronic-display is configured to display the certification-logo-design-status indicating whether the design of the certification-logo is compliant with the design requirements for the certification-mark corresponding to the certification-logo.

4. The label-verification-system of claim 2, wherein the processing-module is configured to compare the certification-logo with a set of standard-certification-marks, to determine a standard-certification-mark most similar to the certification-logo, to evaluate a degree of similarity between the certification-logo and the most similar standard-certification-mark, and to calculate a certification-logo-design-status based on the degree of similarity.

5. The label-verification-system of claim 1, wherein the label-verification-system is configured to access a certificates-database comprising a plurality of product-certificates, wherein the processing-module is configured to input into the certificates-database the label-record; to extract from the certificates-database one or more product-certificates associated with the product-label; to determine for each of the certification-marks on the product-label whether a corresponding valid product-certificate exists in the certificates-database; and to determine a certification-mark-compliance-status for each of the certification-marks.

6. The label-verification-system of claim 5, wherein the label-verification-system is configured to display on the electronic-display each of the certification-marks of the product-label and the corresponding certification-mark-compliance-status.

7. The label-verification-system of claim 5, wherein the label-verification-system is configured to display on the electronic-display the product-certificates for each of the certification-marks for which a product-certificate exists in the certificates-database.

8. A product-registration-system for registering and verifying commercial products, the product-registration-system comprising:
an information-receiving-module configured to receive from a manufacturer-input-device a manufacturer-product-dataset comprising information about a manufacturer-product and the corresponding manufacturer-label;
a registration-module configured to create a registered-product-record corresponding to the received manufacturer-product-dataset;
an information-storage-module comprising a registration-database configured to store the registered-product-record, wherein the registration-database comprises a plurality of product-records corresponding a plurality of commercial products;
an investigation-request-module configured to receive from a user-input-device an investigated-product-dataset corresponding to an investigated-product;
a comparison-module configured to extract product information from the investigated-product-dataset, to determine if the registration-database comprises a product-record matching the investigated-product, to find in the registration-database a matching-registered-product-record for the investigated-product, to compare the information in the investigated-product-dataset with the information in the matching-registered-product-record, and to determine a product-compliance-status for the investigated-product; and
an information-transmission-module configured to send to the user-input-device the product-compliance-status.

9. The product-registration-system of claim 8, wherein the manufacturer-input-device comprises:
a manufacturer-device-camera configured to take photos of the manufacturer-label and the manufacturer-products and to generate manufacturer-label-photos and manufacturer-product-photos;
wherein the product-registration-system is connected with a processing-module configured to perform image recognition on the manufacturer-label-photo and the manufacturer-product-photos, to extract text and images from the photos, and to generate the registered-product-record;
wherein the registered-product-record comprises one or more of the following pieces of information regarding the manufacturer-product and the manufacturer-label: product serial numbers, lot numbers, product information, manufacturer information, one or more certification-logos, certification-marks associated with each of the certification-logos, one or more warning messages, the manufacturer-product-photos, and the manufacturer-label-photos.

10. The product-registration-system of claim 9, wherein the user-input-device comprises:
a user-device-camera configured to take photos of the investigated-product and to generate a set of investigated-product-photos and investigated-label-photos;
a user-device-electronic-display configured to display the product-compliance-status;
wherein the product-registration-system is connected with a processing-module configured to perform image recognition on the investigated-product-photos and the investigated-label-photos, to extract text and images from the investigated-product-photos and investigated-label-photos, and to generate the investigated-product-dataset from the text and images; and
wherein the investigated-product-dataset comprises one or more of the following: product serial numbers, product lot numbers, product information, manufacturer information, one or more certification-logos, certification-marks associated with each of the certification-logos, one or more warning messages, the investigated-product-photos, and the investigated-label-photos.

11. The product-registration-system of claim 10, wherein the comparison-module is further configured to compare the investigated-product-photos with the manufacturer-product-photos and to determine if they match with each other; and wherein the comparison-module is further configured to determine a product-matching-status indicating whether the manufacturer-product-photos and investigated-product-photos match with each other.

12. The product-registration-system of claim 8, further comprising a manufacturer-account configured to hold one or more product-datasets, wherein each of the product-datasets corresponds to a product of the manufacturer; wherein the manufacturer-input-device is configured to display a list of product-datasets in the manufacturer-account.

13. The product-registration-system of claim 10, wherein the registered-product-record comprises one or more record-datasets and each of the datasets is rendered immutable by storing on a blockchain a copy of the datasets.

14. The product-registration-system of claim 10, wherein the registered-product-record comprises one or more record-datasets and each of the datasets is rendered immutable by storing on a blockchain a hash of the dataset.

15. The product-registration-system of claim 8, further comprising a product-authentication-module configured to determine an authenticity-status of the investigated-product, the product-authentication-module further comprising:
a geolocation-module configured to determine a geographical location of the investigated-product by determining the geographical location of the user-input-device and to form a location-record for the investigated-product, the location-record comprising the geographical location of the investigated-product and the corresponding investigation-time;
wherein the authenticity-status of the investigated-product comprises information whether the investigated-product is an authentic-product or a counterfeit-product.

16. The product-registration-system of claim 15, further comprising a chain-of-custody-module configured to receive information about a chain-of-custody for the investigated-product.

17. The product-registration-system of claim 16, wherein for each registered-product-record, the product-authentication-module forms a location-dataset corresponding to the registered-product and its associated registered-product-record;
wherein the location-dataset comprises a plurality of location-records corresponding to instances when user-input-devices, at a plurality of geographical locations and investigation-time, have sent to the product-registration-system investigated-product-datasets leading to the registered-product-record of the registered-product.

18. The product-registration-system of claim 17, wherein the product-authentication-module is configured to estimate the authenticity-status for the investigated-product by analyzing one or more of the following: the product-matching-status, the certification-mark-compliance-status, the chain-of-custody, the location-record of the investigated-product, and the location-dataset.

19. The product-registration-system of claim 17, wherein the product-authentication-module is configured to estimate for each of the location-records if the geographical location and the investigation-time corresponding to the location-record is consistent with the investigation of an authentic product or with the investigation of a counterfeit product.

20. The product-registration-system of claim 18,
wherein the product-authentication-module is configured to estimate the authenticity-status for each of the location-records in the location-dataset by analyzing one or more of the following: the location-record; the location-dataset; and a product-matching-status, a certification-mark-compliance-status, and a chain-of-custody of the investigated product associated with the location-record; and
wherein the product-authentication-module is further configured to display, for the registered-product-record, a list of all the location-records in the location-dataset and their corresponding authenticity-status.

21. A method for verifying the authenticity of a commercial product, the method comprising:
receiving at a user-input-device an investigated-label-photo of an investigated-product-label corresponding to an investigated-commercial-product;
performing image recognition on the investigated-label-photo and extracting text and images from the investigated-label-photo;
generating, from the text and images, an investigated-product-dataset comprising one or more of the following: product serial numbers, product lot numbers, product information, manufacturer information, one or more certification-logos, certification-marks associated with each of the certification-logos, and one or more warning messages;
determining a certification-mark-compliance-status for each of the certification-logos and the corresponding certification-marks; and
displaying, at the user-input-device, the certification-mark-compliance-status for each of the certification-logos.

22. The method of claim 21 for verifying the authenticity of a commercial product, further comprising: comparing each of the certification-logos with a set of standard-certification-logos and determining if the design of the certification-logo is compliant with the design requirements for the certification-mark corresponding to the certification-logo.

23. The method of claim 21 for verifying the authenticity of a commercial product, further comprising: accessing a certificates-database comprising a plurality of product-certificates and determining for each of the certification-marks on the investigated-product-label whether a corresponding valid product-certificate exists in the certificates-database.

24. The method of claim 23 for verifying the authenticity of a commercial product, further comprising one or more of the following:
accessing, via the user-input-device, a product-registration-database comprising a plurality of registered-product-records;
determining if the product-registration-database comprises a registered-product-record matching the investigated-commercial-product;
finding in the label-registration-database a matching-registered-product-record for the investigated-commercial-product and comparing the information in the investigated-product-record with the information in the matching-registered-product-record; and
determining a product-compliance-status for the investigated-product-record and the corresponding investigated-commercial-product;
wherein the registered-product-records are rendered immutable by storing on a blockchain copies of datasets in the registered-product-records or hashes of the datasets in the registered-product-records.

25. The method of claim 24 for verifying the authenticity of a commercial product, further comprising:
receiving at the user-input-device one or more investigated-product-photos of the investigated-commercial-product;
comparing the investigated-product-photos with a set of manufacturer-product-photos stored in the matching-registered-product-record; and
determining a product-matching-status indicating whether the manufacturer-product-photos and the investigated-product-photos match with each other.

26. The method for verifying the authenticity of a commercial product of claim 25, further comprising: receiving at the user-input-device from the registered-product-database one or more product-authenticity-verifying-procedures describing ways to verify the authenticity of the investigated-commercial-product or ways to determine whether the investigated-commercial-product is counterfeit.

27. The method for verifying the authenticity of a commercial product of claim 24, further comprising:
receiving information regarding the chain-of-custody of the product associated with the registered-product-record and storing the information into the registered-product-record;
determining a current-product-geolocation indicating the estimated geographical location of the user-input-device and the corresponding investigation-time;
storing the current-product-geolocation in the registered-product-record;
estimating a product-authenticity-status for the investigated-commercial-product by analyzing one or more of the following: the product-matching-status, the product-compliance-status, the certification-mark-compliance-status, the chain-of-custody, the-current-product-geolocation;

28. The method for verifying the authenticity of a commercial product of claim 27, further comprising:
for each registered-product-record and registered-product, forming a location-dataset comprising a plurality of location-records comprising a geographical location and an investigation-time when a user-input-device accessed the registration-database and the input from the user-input-device led to the registered-product-record;
estimating the authenticity-status for each of the location-records in the location-dataset by analyzing one or more of the following: the location-record; the location-dataset; and a product-matching-status, a certification-mark-compliance-status, and a chain-of-custody of the investigated product associated with the location-record; and
displaying, at a user device, a list of the location-records in the location-dataset and their corresponding authenticity-status.

29. The method for verifying the authenticity of a commercial product of claim 25, further comprising:
wherein the user-input-device is configured to take investigated-product-photos-with-flash and investigated-product-photos-without-flash; and
wherein the manufacturer-product-photos comprise manufacturer-photos-with-flash and manufacturer-photos-without-flash;
wherein the method for verifying the authenticity of a commercial product comprises:
comparing the investigated-product-photos-with-flash with a set of manufacturer-product-photos-with-flash stored in the matching-registered-product-record;
comparing the investigated-product-photos-without-flash with a set of manufacturer-product-photos-without-flash stored in the matching-registered-product-record;
determining a product-matching-status indicating whether the manufacturer-product-photos-with-flash and the investigated-product-photos-with-flash match with each other; and
determining a product-matching-status indicating whether the manufacturer-product-photos-without-flash and the investigated-product-photos-without-flash match with each other.

30. The method for verifying the authenticity of a commercial product of claim 25, wherein the user-input-device comprises a plurality of cameras configured for stereoscopic vision and wherein one or more of the investigated-product-photos and the investigated-label-photos are stereoscopic images.
